(19) United States
(12) Patent Application Publication
(10) Pub. No.: US 2009/0213514 A1
(43) Pub. Date: Aug. 27, 2009

(54) Galvanic isolator

(76) Inventor: Mark Grasser, Eliot, ME (US)

Correspondence Address: KRISTOFER E. ELBING, 187 PELHAM ISLAND ROAD, WAYLAND, MA, 01778, US

(21) Appl. No.: 11/974,493

(22) Filed: Oct. 12, 2007

(51) Int. Cl. H02H 9/02

(52) U.S. Cl. 361/93.1

(57) ABSTRACT

In one general aspect, a galvanic isolator is disclosed. It includes an isolation circuit with at least two diodes placed back-to-back between the input line and the output line. A leakage current detection element is provided between the input line and the output line. A protection circuit is operatively connected to the leakage current detection element.

### FIELD OF THE INVENTION

This invention pertains to galvanic isolators for use in marine applications.

### BACKGROUND OF THE INVENTION

Connecting a boat's electrical system directly to the ground wire of shore power supply can create a common ground configuration that interferes with the vessel's cathodic protection system. This can cause any metal on the boat that is in contact with water to corrode. A galvanic isolator connected between the ground wire of the shore power supply and the boat's ground wire can help to alleviate this problem.

Referring to FIG. 1, galvanic isolators 10 generally introduce one or two diodes 12 in each direction between shore ground 14 and the boat's ground 16. The small forward voltage drop across each diode is sufficient to block low-voltage galvanic current flow, but the diodes can also readily conduct high voltage AC current.

If a short circuit occurs on the boat, the excess ground current should trip a circuit breaker for the shore power line. For this reason, the diodes in prior art galvanic isolators need to be able to safely carry a full short-circuit load for long enough to ensure that the circuit breaker has had a chance to respond.

### SUMMARY OF THE INVENTION

In one general aspect, the invention features a galvanic isolator that includes an input line, an output line, an isolation circuit including at least two diodes placed back-to-back between the input line and the output line, a leakage current detection element between the input line and the output line, and a protection circuit operatively connected to the leakage current detection element.

In preferred embodiments, the leakage detection element can include an inductor. The protection circuit can include a fan. The inductor can be operatively connected to inputs of a rectifier with the fan being operatively connected to outputs of the rectifier.

In another general aspect, the invention features a galvanic isolation method that includes isolating an input line from an output line, detecting leakage currents between the input line and the output line, and activating a protection measure in response to the detection of a leakage current.

In preferred embodiments, the step of activating a protection measure can include activating a cooling step. The step of activating can provide power for the protection measure. The method can further include a step of rectifying the power provided by the step of activating.

In a further general aspect, the invention features a galvanic isolation circuit that includes means for isolating an input line from an output line, means for detecting leakage currents between the input line and the output line, and means for activating a protection measure in response to the detection of a leakage current by the means for detecting. In preferred embodiments, the circuit can further include cooling means responsive to the means for activating.

Systems according to the invention are particularly well-suited to handling leakage faults through a cooling fan or other means. In this type of fault, an increased current is drawn through the isolator, but this current is not sufficient to trip the breaker on the shore supply. This type of fault is generally not readily apparent and can cause significant heating and possible damage to the isolator. Systems according to the invention can activate a protection mechanism to handle this type of failure.

### BRIEF DESCRIPTION OF THE DRAWINGS

FIG. 1 is a schematic diagram illustrating the use of a prior art galvanic isolator;

FIG. 2 is a schematic diagram of an illustrative galvanic isolator according to the invention;

FIG. 3 is a schematic diagram of one type of protection circuit for use with the galvanic isolator of FIG. 2; and

FIG. 4 is a block diagram illustrating the operation of the galvanic isolator of FIG. 2.

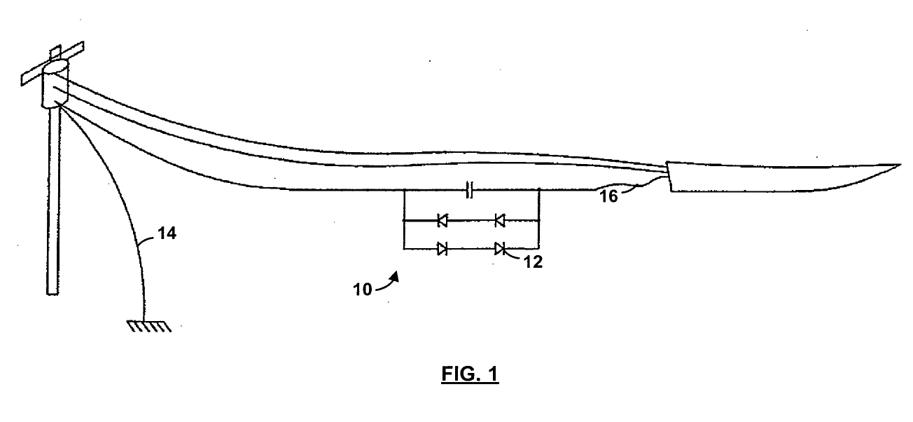

### DESCRIPTION OF AN ILLUSTRATIVE EMBODIMENT

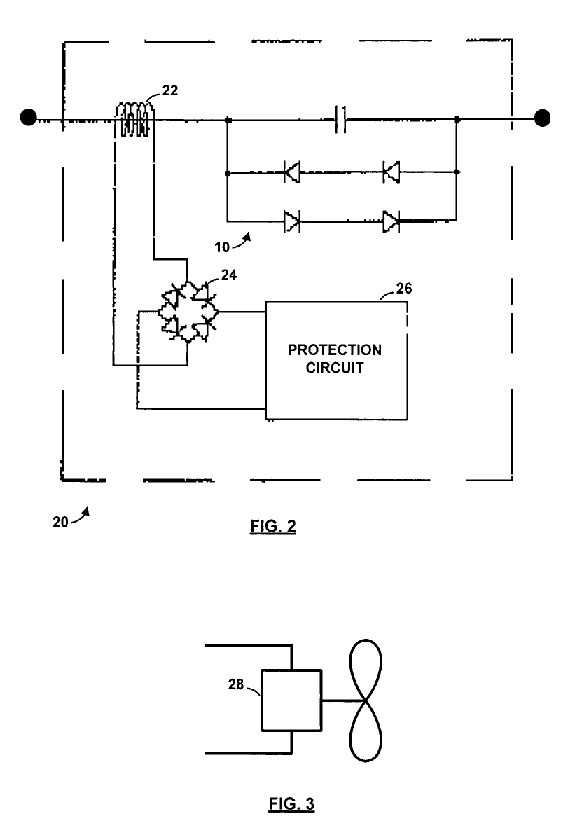

Referring to FIG. 2, an illustrative galvanic isolator 20 according to the invention includes a diode-based isolation circuit 10, which can be a prior art isolation circuit, connected between an input and an output line of the isolator. The isolator also includes an inductor 22 coiled around the input line (or output line). The inductor is operatively connected to inputs of a rectifier 24, such as a full-bridge rectifier, and a protection circuit 26 has two inputs operatively connected to two outputs of the rectifier.

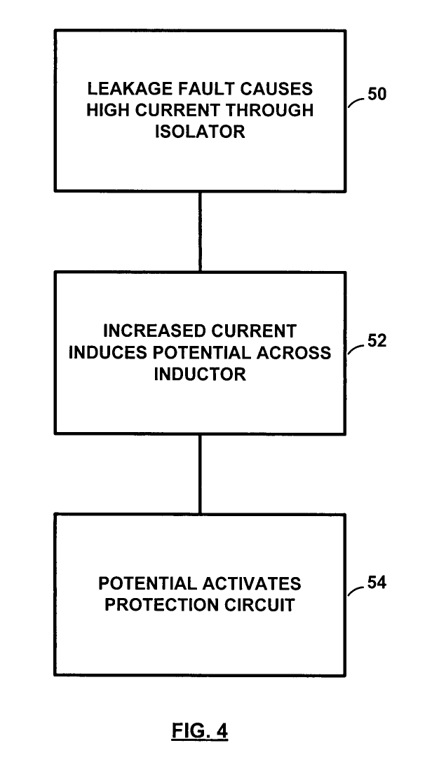

Referring to FIG. 3, the protection circuit can include a fan 28. It can also include a visual or auditory alarm circuit, which can include a visual indicator, such as an LED, or an auditory indicator, such as a buzzer, to alert the user of the leakage condition. The protection circuit can include a shunt switch, as well, to divert current away from the diodes in the isolation circuit 10. These different types of protection circuits can be provided alone or in any combination.

In operation, when a leakage-type fault occurs, it causes an increase in current through the islolator 20 (step 50) that is not sufficient to break the shore supply breaker. This increased alternating current is, however, sufficient to induce a potential difference across the inductor (step 52). The induced potential difference can then activate and/or power a protection circuit (step 54). In a presently preferred embodiment, the induced potential powers the fan 28 to protect the diodes in the isolation circuit by cooling them. This can help to improve the longevity of the isolation diodes, and may allow for the use of smaller diodes in some circumstances.

In one embodiment, the isolator diodes are a ZMF-CS-23055-12 diode, and the isolator capacitor is a 2.5 V 25,000 uF 105 deg. C capacitor. The fan is a Muffin Fan sold by Delta Electronics, Inc. under part number Delta AFB0612SHD. The fan is driven by a varistor-protected supply.

The present invention has now been described in connection with a number of specific embodiments thereof. However, numerous modifications which are contemplated as falling within the scope of the present invention should now be apparent to those skilled in the art. For example, the inductor could be replaced by a device that senses current but does not generate enough power to run the fan, and the fan could run off of another power source. A half-bridge or other type of rectifier could also be used in place of the full-bridge rectifier, or the protection circuit could be designed to run directly from alternating current. It is therefore intended that the scope of the present invention be limited only by the scope of the claims appended hereto. In addition, the order of presentation of the claims should not be construed to limit the scope of any particular term in the claims.

What is claimed is:

1. A galvanic isolator, comprising:
an input line,
an output line,
an isolation circuit including at least two diodes placed back-to-back between the input line and the output line,
a leakage current detection element between the input line and the output line, and
a protection circuit operatively connected to the leakage current detection element.

2. The apparatus of claim 1 wherein the leakage detection element includes an inductor.

3. The apparatus of claim 2 wherein the protection circuit is a fan.

4. The apparatus of claim 3 wherein the inductor is operatively connected to inputs of a rectifier and the fan is operatively connected to outputs of the rectifier.

5. The apparatus of claim 2 wherein the inductor is operatively connected to inputs of a rectifier and the protection circuit is operatively connected to outputs of the rectifier.

6. The apparatus of claim 1 wherein the protection circuit is a fan.

7. A galvanic isolation method, comprising:
isolating an input line from an output line,
detecting leakage currents between the input line and the output line, and
activating a protection measure in response to the detection of a leakage current.

8. The method of claim 7 wherein the step of activating a protection measure includes activating a cooling step.

9. The method of claim 7 wherein the step of activating provides power for the protection measure.

10. The method of claim 9 further including a step of rectifying the power provided by the step of activating.

11. A galvanic isolation circuit, comprising:
means for isolating an input line from an output line,
means for detecting leakage currents between the input line and the output line, and
means for activating a protection measure in response to the detection of a leakage current by the means for detecting.

12. The apparatus of claim 11 further including cooling means responsive to the means for activating.
